(19) United States
(12) Patent Application Publication
(10) Pub. No.: US 2023/0298385 A1
(43) Pub. Date: Sep. 21, 2023

(54) METHOD AND DEVICE FOR FINGERPRINT ENROLLMENT, AND NON-TRANSITORY COMPUTER-READABLE STORAGE MEDIUM

(71) Applicant: Egis Technology Inc., Hsinchu City (TW)

(72) Inventors: YUAN-LIN CHIANG, Hsinchu City (TW); YU-CHUN CHENG, Hsinchu City (TW); CHIEH-PIN SU, Hsinchu City (TW)

(21) Appl. No.: 18/071,805

(22) Filed: Nov. 30, 2022

Related U.S. Application Data
(60) Provisional application No. 63/321,775, filed on Mar. 21, 2022.

(30) Foreign Application Priority Data
Oct. 20, 2022 (CN) 202211288085.9

(51) Int. Cl. G06V 40/50; G06V 40/12; G06V 40/60

(52) U.S. Cl. CPC G06V 40/50; G06V 40/1335; G06V 40/1371; G06V 40/67

(57) ABSTRACT

A method for fingerprint enrollment according to an embodiment includes extracting fingerprint feature points of a fingerprint image, fragmenting the fingerprint image in units of each fingerprint feature point, to obtain a feature fragment corresponding to each fingerprint feature point, and determining, according to whether the feature fragment meets an enrollment condition, whether the fingerprint enrollment is completed. Each fingerprint image can be fully utilized, so that the count of presses on the fingerprint sensor by a user of fingerprint enrollment is reduced, and the enrollment experience of the user is improved.

### CROSS REFERENCE TO RELATED APPLICATIONS AND CLAIM OF PRIORITY

This application claims the benefit under 35 USC § 119 of U.S. Patent Application No. 63/321,775 filed on Mar. 21, 2022 and Chinese Patent Application No. 202211288085.9 filed on Oct. 20, 2022 at the Chinese Intellectual Property Office, the disclosures of which are incorporated by reference herein in their entirety.

### BACKGROUND

### 1. Technical Field

The present disclosure generally relates to the technical field of fingerprint enrollment. More specifically, the present disclosure relates to a method and a device for fingerprint enrollment, and a non-transitory computer-readable storage medium.

### 2. Background of the Invention

With the continuous development of information technology, the fingerprint verification technology has been widely applied to portable electronic devices or access control devices for user identity authentication. The conventional fingerprint enrollment method comprises identifying quality of a fingerprint image generated by a user pressing a fingerprint sensor each time to determine whether each fingerprint image can be used for fingerprint enrollment, and completing the fingerprint enrollment until a count of received fingerprint images meeting the quality requirement reaches a preset count.

With such a fingerprint enrollment method, fingerprint enrollment users, either with good pressing quality or with poor pressing quality, are required to press the fingerprint sensor for at least a certain count of times before completing the fingerprint enrollment, which reduces the use experience of users of fingerprint enrollment with good pressing quality.

### SUMMARY

To address at least one or more of the above technical problems, the present disclosure proposes, in various aspects, a method and a device for fingerprint enrollment, and a non-transitory computer-readable storage medium.

In a first aspect, the present disclosure provides a method for fingerprint enrollment, comprising: extracting fingerprint feature points of a fingerprint image; fragmenting the fingerprint image in units of each fingerprint feature point, to obtain a feature fragment corresponding to each fingerprint feature point; and determining, according to whether the feature fragment meets an enrollment condition, whether the fingerprint enrollment is completed.

In some embodiments, the method further comprises: determining a valid feature fragment of the fingerprint image; and determining, according to whether an information amount of the valid feature fragment meets the enrollment condition, whether the fingerprint enrollment is completed.

In some other embodiments, determining the valid feature fragment of the fingerprint image comprises: determining, according to fingerprint feature points in each fingerprint image not repetitive with those in other previously acquired fingerprint images, the valid feature fragment of each fingerprint image.

In still other embodiments, determining, according to whether the information amount of the valid feature fragment meets the enrollment condition, whether the fingerprint enrollment is completed comprises: determining, according to a degree of contribution of the valid feature fragment to the fingerprint information, a total score that represents the information amount of all valid feature fragments; and determining, according to whether the total score reaches a preset threshold, whether the fingerprint enrollment is completed.

In some embodiments, determining the total score according to the degree of contribution comprises: determining, according to sharpness of each valid feature fragment, a first score that represents an information amount of each valid feature fragment; and/or determining, according to an area of a spliced image formed by all valid feature fragments, a second score that represents an information amount of the spliced image.

In some other embodiments, determining the total score according to the degree of contribution comprises: splicing all valid feature fragments according to correlation among the valid feature fragments, to form a spliced image; determining, according to an area of the spliced image where each valid feature fragment is located and sharpness of each valid feature fragment, a third score that represents an information amount of each valid feature fragment; and determining, according to a sum of third scores of all valid feature fragments, a total score that represents the information amount of all valid feature fragments.

In still other embodiments, the method further comprises: displaying a fingerprint enrollment progress based on at least one of: a progress of obtaining the valid feature fragment; or the information amount of the valid feature fragment.

In some embodiments, determining, according to whether the feature fragment meets the enrollment condition, whether the fingerprint enrollment is completed comprises: acquiring a next fingerprint image in response to that current pre-enrolled feature fragments do not meet the enrollment condition, until the feature fragments accumulated in all the fingerprint images meet the enrollment condition, and determining that the fingerprint enrollment is completed.

In a second aspect, the present disclosure provides a device for fingerprint enrollment, comprising: a fingerprint sensor configured to detect a fingerprint image of a finger; and a processor configured to: extract fingerprint feature points of a fingerprint image; fragment the fingerprint image in units of each fingerprint feature point, to obtain a feature fragment corresponding to each fingerprint feature point; and determine, according to whether the feature fragment meets an enrollment condition, whether the fingerprint enrollment is completed.

In some embodiments, the processor is further configured to: determine a valid feature fragment of the fingerprint image; and determine, according to whether an information amount of the valid feature fragment meets the enrollment condition, whether the fingerprint enrollment is completed.

In some other embodiments, the processor is further configured to: determine, according to fingerprint feature points in each fingerprint image not repetitive with those in other previously acquired fingerprint images, the valid feature fragment of each fingerprint image.

In still other embodiments, the processor is further configured to: determine, according to a degree of contribution of the valid feature fragment to the fingerprint information, a total score that represents the information amount of all valid feature fragments; and determine, according to whether the total score reaches a preset threshold, whether the fingerprint enrollment is completed.

In some embodiments, in determining the total score according to the degree of contribution, the processor is further configured to: determine, according to sharpness of each valid feature fragment, a first score that represents an information amount of each valid feature fragment; and/or determine, according to an area of a spliced image formed by all valid feature fragments, a second score that represents an information amount of the spliced image.

In some other embodiments, in determining the total score according to the degree of contribution, the processor is further configured to: splice all valid feature fragments according to correlation among the valid feature fragments, to form a spliced image; determine, according to an area of the spliced image where each valid feature fragment is located and sharpness of each valid feature fragment, a third score that represents an information amount of each valid feature fragment; and determine, according to a sum of third scores of all valid feature fragments, a total score that represents the information amount of all valid feature fragments.

In still other embodiments, the device further comprises: a display; and the processor is further configured to: control the display to display a fingerprint enrollment progress based on at least one of: a progress of obtaining the valid feature fragment; or the information amount of the valid feature fragment.

In some embodiments, the processor is further configured to: acquire a next fingerprint image in response to that current pre-enrolled feature fragments do not meet the enrollment condition, until the feature fragments accumulated in all the fingerprint images meet the enrollment condition, and determine that the fingerprint enrollment is completed.

In a third aspect, the present disclosure provides a non-transitory computer-readable storage medium having a program for fingerprint enrollment stored thereon which, when executed by a processor, causes any method according to the first aspect of the present disclosure to be performed.

Through the above description of the technical solutions of the present disclosure and embodiments thereof, those skilled in the art will understand that the method for fingerprint enrollment of the present disclosure can obtain corresponding feature fragments in units of each fingerprint feature point in a fingerprint image, instead of in units of a fingerprint image, and determine whether the fingerprint enrollment is completed according to the feature fragments, so that useful information in each fingerprint image can be fully utilized to reduce the count of presses on the fingerprint sensor by a user of fingerprint enrollment, thereby improving the enrollment experience of the user.

Further, in some embodiments, a total score is determined according to a degree of contribution of the valid feature fragment to the fingerprint information, to determine whether the fingerprint enrollment is completed, and the degree of contribution of each valid feature fragment to the fingerprint enrollment can be considered, so that considering the quality of different feature points in each fingerprint image, different users of fingerprint enrollment can reach a uniform fingerprint enrollment standard with different counts of presses.

### BRIEF DESCRIPTION OF THE DRAWINGS

The above and other objectives, features and advantages of the exemplary embodiments of the present disclosure will become readily apparent from the following detailed description, which proceeds with reference to the accompanying drawings. In the accompanying drawings, several embodiments of the present disclosure are illustrated by way of example but not limitation, and like or corresponding reference numerals indicate like or corresponding parts, in which:

FIG. 1 is a schematic flowchart of a method for fingerprint enrollment according to an embodiment of the present disclosure;

FIG. 2A is a schematic diagram of extracting fingerprint feature points of a fingerprint image according to an embodiment of the present disclosure;

FIG. 2B is a schematic diagram of extracting fingerprint feature points of a fingerprint image according to another embodiment of the present disclosure;

FIG. 2C is a schematic diagram of extracting fingerprint feature points of a fingerprint image according to yet another embodiment of the present disclosure;

FIG. 3 is a schematic flowchart of a method for fingerprint enrollment according to another embodiment of the present disclosure;

FIG. 4A is a schematic comparison diagram of effects between the method for fingerprint enrollment according to an embodiment of the present disclosure and a method for fingerprint enrollment in units of a count of images for good users;

FIG. 4B is a schematic comparison diagram of effects between the method for fingerprint enrollment according to an embodiment of the present disclosure and a method for fingerprint enrollment in units of a count of images for poor users; and

FIG. 5 is a schematic block diagram of a device for fingerprint enrollment according to an embodiment of the present disclosure.

### DETAIL DESCRIPTION

The technical solutions in the embodiments of the present disclosure will be clearly and completely described below with reference to the accompanying drawings in the embodiments of the present disclosure. Apparently, the described embodiments are only some of the embodiments of the present disclosure, but not all of them. All other embodiments, which can be derived by those skilled in the art from the embodiments of the present disclosure without making any creative effort, shall fall within the protection scope of the present disclosure.

It will be understood that the terms “comprise” and “include,” when used in the description and claims of the present disclosure, specify the presence of stated features, integers, steps, operations, elements, and/or components, but do not preclude the presence or addition of one or more other features, integers, steps, operations, elements, components, and/or combinations thereof.

It is also to be understood that the terminology used in the description of the disclosure herein is for the purpose of describing particular embodiments only, and is not intended to limit the disclosure. As used in the description and claims of the present disclosure, the singular forms “a”, “an” and “the” are intended to include the plural forms, unless the context clearly indicates otherwise. It should be further understood that the term “and/or” as used in the description and claims of the present disclosure refers to any and all possible combinations of one or more of the associated listed items and includes such combinations.

As used in the description and the claims, the term “if” may be interpreted contextually as “when” or “once”, or “in response to determining”, or “in response to detection of” Similarly, the phrase “if it is determined” or “if [the described condition or event] is detected” may be interpreted contextually as “upon determining” or “in response to determining” or “upon detection of [the described condition or event]” or “in response to detection of [the described condition or event].”

In view of deficiencies of the prior art, the present disclosure provides a completely new and feasible solution. In particular, the method for fingerprint enrollment of the present disclosure can fragment each fingerprint image in units of fingerprint feature point, and determine, according to the feature fragments, whether the enrollment condition is met, so that useful information in each fingerprint image can be fully utilized to avoid wasting the collected fingerprint images, thereby helping to reduce the count of presses required for a user to complete the fingerprint enrollment, and further improving the fingerprint enrollment experience of the user.

As will be understood by those skilled in the art in light of the following description, the present disclosure further provides various implementations for determining whether the fingerprint enrollment is completed based on fingerprint fragments in various embodiments. For example, in some embodiments, whether the fingerprint enrollment is completed may be determined based on an information amount of a valid feature fragment, which can eliminate the influence of invalid feature fragments on fingerprint enrollment. In some other embodiments, a total score may be determined according to a degree of contribution of the valid feature fragment to the fingerprint information, to determine whether the fingerprint enrollment is completed. In this manner, the importance degrees of different feature fragments are considered, so that although the count of presses and the count of fingerprint images may differ for different users of fingerprint enrollment, the fingerprint enrollment can still be performed based on the same enrollment standard. Specific embodiments of the present disclosure will be described in detail below with reference to the accompanying drawings.

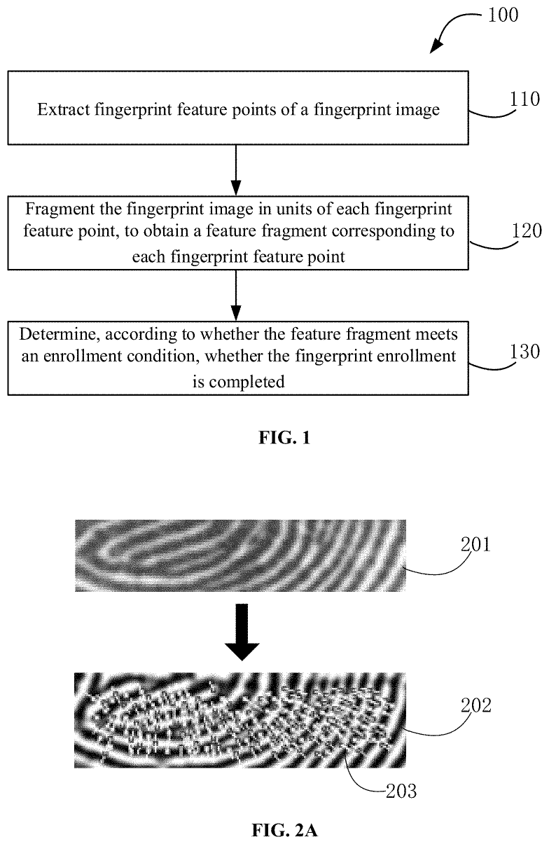

FIG. 1 is a schematic flowchart of a method for fingerprint enrollment according to an embodiment of the present disclosure. As shown in FIG. 1, the method 100 may comprise a step 110. In step 110, fingerprint feature points of a fingerprint image may be extracted. In some other embodiments, the fingerprint feature points may include local feature points such as end points, bifurcation points, short lines, and the like. In still other embodiments, the fingerprint feature points may include feature points at each minutia in the fingerprint image. In some embodiments, during the fingerprint extraction, information such as positions (e.g., coordinates), angles, and features (e.g., shapes, directions, or textures) of these fingerprint feature points may be obtained simultaneously. Extracting fingerprint feature points of the fingerprint image may be implemented by an existing or future achievable feature extraction method, such as a ridge tracking algorithm or the like.

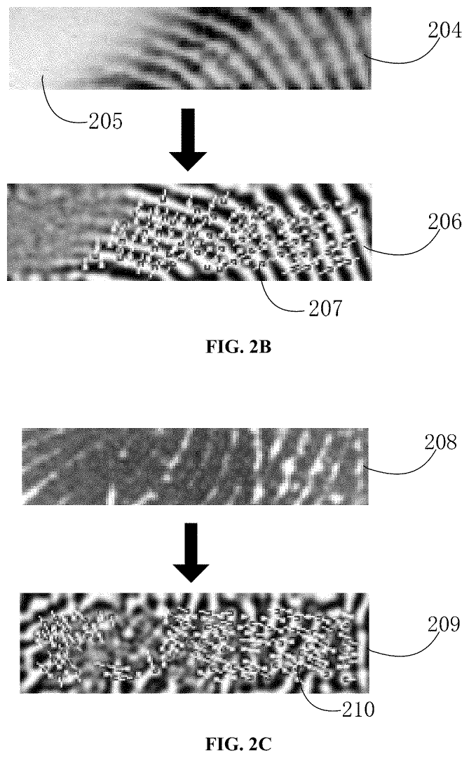

It will be understood that the step of extracting fingerprint feature points according to the embodiment of the present disclosure may be not limited to be performed on a complete and clear fingerprint image, but may also be performed on a captured fingerprint image with poor quality. For ease of understanding, the following exemplary description is made in conjunction with FIGS. 2A to 2C.

FIG. 2A is a schematic diagram of extracting fingerprint feature points of a fingerprint image according to an embodiment of the present disclosure. As shown in FIG. 2A, a fingerprint image 201 may be subjected to processing such as image enhancement, binarization and the like to obtain, for example, a fingerprint image 202 as shown in the figure, and then fingerprint feature points may be extracted from the processed fingerprint image 202 to obtain a plurality of fingerprint feature points 203. In some other embodiments, fingerprint feature points may be directly extracted from the originally captured fingerprint image 201.

FIG. 2B is a schematic diagram of extracting fingerprint feature points of a fingerprint image according to another embodiment of the present disclosure. Compared with the fingerprint image 201 shown in FIG. 2A, there is a fingerprint-free region 205 in a fingerprint image 204 shown in FIG. 2B, so that the fingerprint image 204 has less fingerprint information. In the conventional fingerprint enrollment method, the fingerprint image 204 will be rejected for fingerprint enrollment.

However, as shown in FIG. 2B, in the method according to the embodiment of the present disclosure, the fingerprint image 204 may be subjected to processing such as image enhancement, binarization and the like to obtain, for example, a fingerprint image 206 as shown in the figure, and then fingerprint feature points may be extracted from the processed fingerprint image 206 to obtain a plurality of fingerprint feature points 207. Since the method according to the embodiment of the present disclosure is performed in units of fingerprint feature point, instead of totally rejecting a fingerprint image like the fingerprint image 204 with the fingerprint-free region 205, available fingerprint feature points 207 can still be extracted from the fingerprint image 204 for fingerprint enrollment. In some other embodiments, fingerprint feature points may be directly extracted from the originally captured fingerprint image 204.

FIG. 2C is a schematic diagram of extracting fingerprint feature points of a fingerprint image according to yet another embodiment of the present disclosure. Compared with the fingerprint image 201 shown in FIG. 2A, a fingerprint image 208 shown in FIG. 2C has a lower sharpness, so that less fingerprint information can be extracted from the fingerprint image 208. In the conventional fingerprint enrollment method, the fingerprint image 208 will be rejected for fingerprint enrollment.

In contrast, as shown in FIG. 2C, in the method according to the embodiment of the present disclosure, the fingerprint image 208 may be subjected to processing such as image enhancement, binarization and the like to obtain, for example, a fingerprint image 209 as shown in the figure, and then fingerprint feature points may be extracted from the processed fingerprint image 209 to obtain a plurality of fingerprint feature points 210. Since the method according to the embodiment of the present disclosure is performed in units of fingerprint feature point, instead of totally rejecting a fingerprint image like the fingerprint image 208 with low sharpness, available fingerprint feature points 210 can still be extracted from the fingerprint image 208 for fingerprint enrollment. In some other embodiments, fingerprint feature points may be directly extracted from the originally captured fingerprint image 208.

The description will be continued with reference to FIG. 1 again. As shown in FIG. 1, after the fingerprint feature points are obtained in step 110, a step 120 may be further performed. In step 120, the fingerprint image may be fragmented in units of each fingerprint feature point, to obtain a feature fragment corresponding to each fingerprint feature point. Fragmentation may be understood as a process of dividing a fingerprint image into a plurality of small parts. Fragmenting in units of each fingerprint feature point may enable each feature fragment to contain one fingerprint feature point. In some embodiments, the fingerprint image may be divided into a plurality of feature fragments by taking each fingerprint feature point as a center and cutting according to a preset shape or a preset radius, or cutting at a middle position between adjacent fingerprint feature points, or the like, and each feature fragment contains a corresponding fingerprint feature point.

Then, the process may proceed to step 130, where whether the fingerprint enrollment is completed may be determined according to whether the feature fragment meets an enrollment condition. In some embodiments, the enrollment condition may include at least one of: a count of feature fragments that reaches a count threshold; an information amount in the feature fragments that reaches an information amount threshold; a fingerprint area formed by splicing the feature fragments that reaches an area threshold; or the like. In some other embodiments, whether the fingerprint enrollment is completed may be determined based on whether all the feature fragments obtained from the fingerprint images are accumulated to meet the enrollment condition.

In still other embodiments, step 130 may comprise: determining, in response to that the currently obtained feature fragments meet the enrollment condition, that the fingerprint enrollment is completed; or acquiring a next fingerprint image in response to that the currently obtained feature fragments do not meet the enrollment condition, until the feature fragments accumulated in all the fingerprint images meet the enrollment condition, and determining that the fingerprint enrollment is completed. The “all the fingerprint images” herein may include all fingerprint images currently collected for a same finger.

In some application scenarios, when the feature fragments obtained from one captured fingerprint image do not meet the enrollment condition, a visible or audible prompt may be given to the user to prompt him/her to press the finger again, so that a next fingerprint image is acquired. In some other application scenarios, the fingerprint enrollment can be completed when the feature fragments obtained from a plurality of fingerprint images are accumulated to meet the enrollment condition, and at this moment, a visible or audible prompt may be given to the user to prompt him/her that no more finger press is needed.

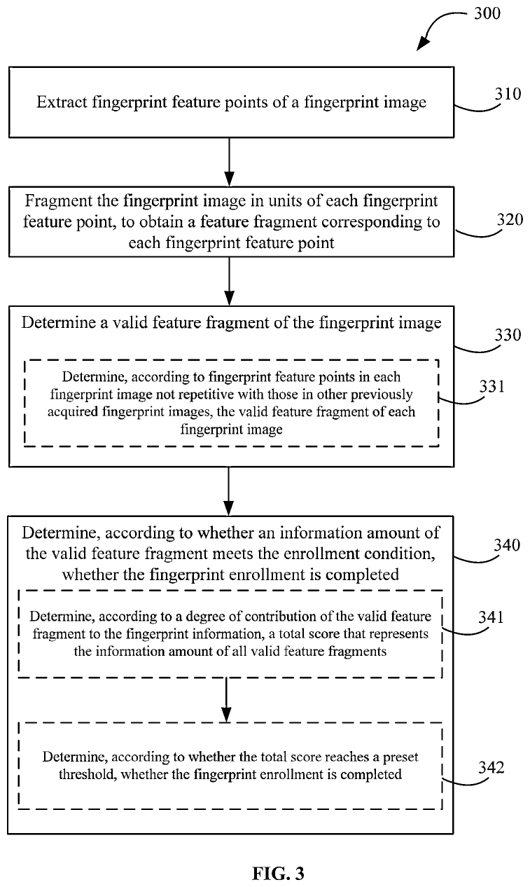

While the method for fingerprint enrollment according to an embodiment of the present disclosure is exemplarily described above with reference to FIG. 1, it will be understood that the above description is exemplary and not restrictive. For example, in step 130, it may be not limited to determining whether the fingerprint enrollment is completed based on whether all the feature fragments obtained from the fingerprint images meet the enrollment condition, and instead, in some embodiments, whether the fingerprint enrollment is completed may determine based on whether a valid feature fragment in the fingerprint image meets the enrollment condition. For ease of understanding, the following exemplary explanation will be made in conjunction with FIG. 3.

FIG. 3 is a schematic flowchart of a method for fingerprint enrollment according to another embodiment of the present disclosure. As will be understood from the following description, the method 300 shown in FIG. 3 may be an embodied representation of the method 100 described above in connection with FIG. 1. Therefore, the description of method 100 above in connection with FIG. 1 may also be applicable to the description of method 300 below.

As shown in FIG. 3, the method 300 may comprise steps 310 to 340. In step 310, fingerprint feature points of a fingerprint image may be extracted. Next, in step 320, the fingerprint image may be fragmented in units of each fingerprint feature point, to obtain a feature fragment corresponding to each fingerprint feature point. The steps 310 and 320 have been described in detail above with reference to steps 110 and 120 shown in FIG. 1, and will not be repeated here.

Then, the process may proceed to step 330, where a valid feature fragment of the fingerprint image may be determined. In some embodiments, the valid feature fragment may be determined among all the obtained feature fragments. In some other embodiments, valid fingerprint feature points may be determined from the plurality of fingerprint feature points extracted in step 310, and then in step 320, the fingerprint image is fragmented in units of each valid fingerprint feature point, to obtain a valid feature fragment corresponding to each valid fingerprint feature point.

In some embodiments, the valid feature fragment may include a feature fragment that may be used for fingerprint enrollment. In some other embodiments, the valid feature fragment may include a non-repetitive feature fragment that can be used for fingerprint enrollment. For example, as shown in FIG. 3, the step 330 may comprise a step 331. In step 331 (shown by a dashed box), the valid feature fragment of each fingerprint image may be determined according to fingerprint feature points in each fingerprint image not repetitive with those in other previously acquired fingerprint images.

Specifically, for a first acquired fingerprint image, all feature fragments in the first fingerprint image may be determined as valid feature fragments. For a non-first acquired fingerprint image, it may be determined, according to similarities between fingerprint feature points extracted from a current fingerprint image and fingerprint feature points in other fingerprint images acquired before the current fingerprint image, whether the current fingerprint image comprises fingerprint feature points which are repetitive with fingerprint feature points in other previous fingerprint images. If there are repetitive fingerprint feature points, the current repetitive fingerprint feature points and corresponding feature fragments are deleted, while feature fragments corresponding to other non-repetitive fingerprint feature points are determined as valid feature fragments in the current fingerprint image.

In some embodiments, in step 331, the fingerprint image may be fragmented according to the non-repetitive fingerprint feature points, to obtain a feature fragment corresponding to each non-repetitive fingerprint feature point as the valid feature fragment. In some other embodiments, in step 331, according to the non-repetitive fingerprint feature points, feature fragments corresponding to the non-repetitive fingerprint feature points may be screened out from all the feature fragments obtained by the fragmentation, and serve as valid feature fragments.

After the valid feature fragment is determined, the process may proceed to step 340. As shown in FIG. 3, in step 340, whether the fingerprint enrollment is completed may be determined according to whether an information amount of the valid feature fragment meets the enrollment condition. The information amount is a measure of how much information there is. Since the valid feature fragment may be a non-repetitive feature fragment, the information in different valid feature fragments may differ. The information contained in the valid feature fragment may include at least information of the fingerprint feature point on the valid feature fragment. Therefore, the information amount of the valid feature fragment may include at least an information amount of the fingerprint feature point on the valid feature fragment.

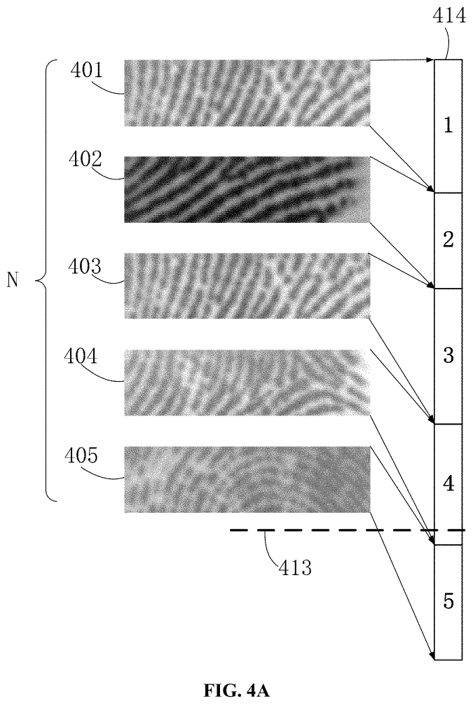

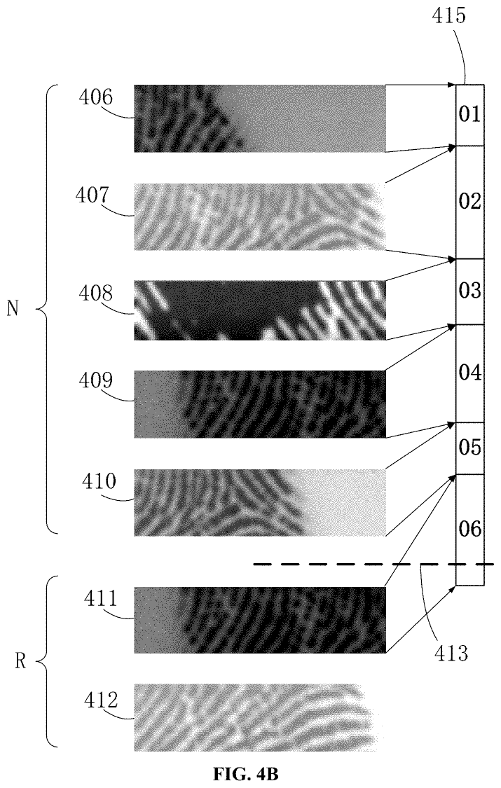

By determining whether the fingerprint enrollment is completed based on the information amount of the valid feature fragment, the method of the present disclosure may be applicable to the situation where the information amount obtained from the fingerprint images differs with different users of fingerprint enrollment and different counts of presses, so that any input information will not be wasted, while the enrollment standard is unified, and different users of fingerprint enrollment have a same or similar information amount of enrolled fingerprint information. To further understand the differences from the conventional fingerprint enrollment method, a comparison is made below with reference to FIGS. 4A and 4B.

FIG. 4A is a schematic comparison diagram of effects between the method for fingerprint enrollment according to an embodiment of the present disclosure and a method for fingerprint enrollment in units of a count of images for good users. FIG. 4B is a schematic comparison diagram of effects between the method for fingerprint enrollment according to an embodiment of the present disclosure and a method for fingerprint enrollment in units of a count of images for poor users. The present inventors have found that, in the conventional fingerprint enrollment method, whether the enrollment condition is met is typically determined in units of a count of fingerprint images. In other words, a preset value of the count of desired images is predetermined, and the fingerprint enrollment is completed when the count of collected fingerprint images reaches the preset value.

Further, in order to guarantee the enrollment quality, acceptable conditions for the fingerprint images may be set. For example, a fingerprint image with a small information amount and/or repetitive information is not accepted. In other words, the fingerprint image may be completed only when the count of acceptable fingerprint images reaches the preset value. However, the setting of the acceptable conditions further increases the count of presses required for a user, thereby reducing the user experience. Still further, in order to avoid the problem that the user experience is reduced due to an excessive count of presses on the fingerprint sensor by the user, a tolerance value for the count of unacceptable fingerprint images may be further provided.

For example, in some application scenarios, assuming that the preset count of fingerprint images required for enrollment is at least N (i.e., the preset value is N), and the count of unacceptable fingerprint images is at most R (i.e., the tolerance value is R), then the count of fingerprint images required for fingerprint enrollment is between N and N+R. According to such arrangement, a user of fingerprint enrollment with good pressing quality still needs to press the fingerprint sensor for at least N times to complete the fingerprint enrollment, while for a user of fingerprint enrollment with poor pressing quality, the fingerprint enrollment may be completed after the whole N+R times, where only N fingerprint images are selected from the N+R fingerprint images for enrollment, and other R fingerprint images with poor quality are abandoned.

As shown in FIG. 4A, taking the preset value N being 5 as an example for illustration, for a good user (i.e., a user of fingerprint enrollment with good pressing quality), in the conventional method which takes the count of fingerprint images as the enrollment condition, before the fingerprint enrollment is completed, the fingerprint sensor is desired to be pressed for at least five times to obtain five fingerprint images 401, 402, 403, 404 and 405.

As further shown in FIG. 4A, in the method according to the embodiment of the present disclosure, a first progress bar 414 is used to represent an accumulated information amount of valid feature fragments from fingerprint images of a good user, and each grid in the first progress bar 414 is used to represent an information amount of the valid feature fragment corresponding to one fingerprint image, where the correspondence relationship between the fingerprint images and the grids is shown by the arrows in the figure. For example, a grid 1 of the first progress bar 414 indicates the information amount of the valid feature fragment in the first fingerprint image 401, a gird 2 indicates the information amount of the valid feature fragment in the second fingerprint image 402, a gird 3 indicates the information amount of the valid feature fragment in the third fingerprint image 403, a gird 4 indicates the information amount of the valid feature fragment in the fourth fingerprint image 404, and a gird 5 indicates the information amount of the valid feature fragment in the fifth fingerprint image 405.

By indicating the enrollment condition with the dashed line 413 in the figure, it can be seen that for a good user, the enrollment condition 413 is met when the valid feature fragment of the fourth fingerprint image is accumulated. In contrast, the method according to the embodiment of the present disclosure obtains the feature fragments in units of fingerprint feature points in a fingerprint image, and determines whether the fingerprint enrollment is completed according to the information amount of the accumulated feature fragments, so that the count of presses can be reduced for a good user.

Next, as shown in FIG. 4B, taking the preset value N being 5 and the tolerance value R being 2 as an example for illustration, for a poor user (i.e., a user of fingerprint enrollment with poor pressing quality), assuming that the user presses the fingerprint sensor for five times and obtains five fingerprint images 406, 407, 408, 409 and 410, but there are two fingerprint images which do not meet the acceptable conditions, so the poor user needs to press twice more on the fingerprint sensor to obtain two additional fingerprint images 411 and 412. Therefore, the poor user needs to press seven times (N+R) on the fingerprint sensor to complete the fingerprint enrollment.

Among the five fingerprint images 406, 407, 408, 409 and 410 of the poor user as shown in FIG. 4B, there is a fingerprint-free region in the first fingerprint image 406, so the first fingerprint image 406 has a smaller information amount; while the fifth fingerprint image 410 comprises not only a fingerprint-free region but also repetitive fingerprint information with other fingerprint images, so the fifth fingerprint image 410 has an even smaller information amount. In the conventional fingerprint enrollment method, the first fingerprint image 406 and the fifth fingerprint image 410 will be completely rejected and not used in enrollment of fingerprint information.

As further shown in FIG. 4B, in the method according to the embodiment of the present disclosure, a second progress bar 415 is used to represent an accumulated information amount of valid feature fragments from fingerprint images of a poor user, and each grid in the second progress bar 415 is used to represent an information amount of the valid feature fragment corresponding to one fingerprint image, where the correspondence relationship between the fingerprint images and the grids is shown by the arrows in the figure. For example, a grid 01 of the second progress bar 415 indicates the information amount of the valid feature fragment in the first fingerprint image 406, a gird 02 indicates the information amount of the valid feature fragment in the second fingerprint image 407, a gird 03 indicates the information amount of the valid feature fragment in the third fingerprint image 408, a gird 04 indicates the information amount of the valid feature fragment in the fourth fingerprint image 409, a gird 05 indicates the information amount of the valid feature fragment in the fifth fingerprint image 410, and a gird 06 indicates the information amount of the valid feature fragment in the sixth fingerprint image 411.

For the first fingerprint image 406, although a non-fingerprint region takes a large area, a certain amount of feature fragments can still be obtained to extract an information amount as shown in grid 01. For the fifth fingerprint image 410, in spite of the non-fingerprint region and repetitive fingerprint information, there is still non-repetitive fingerprint information, from which a certain count of fingerprint feature points and feature fragments can be extracted, and a smaller information amount as shown in grid 05 can be obtained.

By indicating the enrollment condition with the dashed line 413 in the figure, it can be seen that for a poor user, since no information of any fingerprint image is wasted, the enrollment condition 413 is met when the valid feature fragment of the sixth fingerprint image is accumulated. Although the first fingerprint image 406 and the fifth fingerprint image 410 are shown with a smaller information amount (i.e., corresponding to grids 01 and 05) of valid feature fragments, they may still contribute to reaching the enrollment condition, only to a lesser extent.

It can be seen from the above comparison that, with the conventional fingerprint enrollment method, a good user needs to press at least five times to complete the fingerprint enrollment, while a poor user needs to press at least seven times to complete the fingerprint enrollment; but when the fingerprint enrollment is performed in the method according to the embodiment of the present disclosure, a good user can complete the fingerprint enrollment after pressing the fingerprint sensor for four times, while a poor user can complete the enrollment only by pressing the fingerprint sensor for six times, where both users press fewer times than in the solution of performing fingerprint enrollment in units of images. Therefore, the method according to the embodiment of the present disclosure obtains the feature fragments in units of fingerprint feature points in a fingerprint image, and determines whether the fingerprint enrollment is completed according to the information amount of the accumulated feature fragments, so that the count of presses can be reduced for different types of users.

While the method according to the embodiment of the present disclosure and the method for fingerprint enrollment in units of images are described above with reference to FIGS. 4A and 4B, it will be understood that the illustration is exemplary and not restrictive. For example, N may be not limited to 5, and R may be not limited to 2, but no matter which values N and R are set, the method according to the embodiment of the present disclosure can still reduce the desired count of presses by a user in fingerprint enrollment while the enrollment condition is met.

Further, as can be seen from the fingerprint images in FIG. 4B, in the conventional fingerprint enrollment method, although a poor user presses for seven times, still only five fingerprint images (i.e., fingerprint images 407, 408, 409, 411, and 412) are used for fingerprint enrollment. Further, there may be still an image of poor quality (e.g., the fingerprint image 408) among the five fingerprint images for enrollment, so the amount of fingerprint information that can be used for enrollment actually still does not reach the same level as the five fingerprint images of the good user as shown in, for example, FIG. 4A. In contrast, by setting the valid feature fragments accumulated to reach the enrollment condition, the embodiment of the present disclosure enables both good users and poor users to acquire and enroll the fingerprint information under the same enrollment standard, and avoids the case where a poor user cannot obtain the same level of information amount as the good user shown in FIG. 4A even after pressing for seven times, as shown in FIG. 4B, which may affect the enrollment quality and effect.

The description will be continued with reference to FIG. 3 again. As further shown in FIG. 3, in some embodiments, the step 340 may include a step 341. In step 341 (shown by a dashed box), a total score that represents the information amount of all valid feature fragments may be determined according to a degree of contribution of the valid feature fragment to the fingerprint information. In some embodiments, the degree of contribution may be determined according to at least one of, for example, sharpness, an area, or key feature points or not, of fingerprint feature points on the valid feature fragment, or the like, where the key feature points may include feature points with uniqueness and high differentiability, such as end points, bifurcation points, short lines, ring points, isolated points, and the like.

In some other embodiments, determining the total score may include determining a score of each valid feature fragment according to the degree of contribution of each valid feature fragment, and then summing scores of all of the respective valid feature fragments to obtain the total score. In still other embodiments, the score of each valid feature fragment may be obtained from weighted scores of a plurality of determination conditions which represent the degree of contribution. For example, when the degree of contribution is determined from the sharpness and key feature point or not, a score that represents the sharpness and a score that represents key feature points or not may be respectively given corresponding weights according to the sharpness and an importance degree of the key feature point, to determine the total score by calculating a weighted sum score.

In some embodiments, the step 341 may include: determining, according to sharpness of each valid feature fragment, a first score that represents an information amount of each valid feature fragment; and/or determining, according to an area of a spliced image formed by all valid feature fragments, a second score that represents an information amount of the spliced image. In some other embodiments, the higher the sharpness of the valid feature fragment is, the higher the first score it receives. In still other embodiments, the larger the area of the spliced image formed by all valid feature fragments is, the higher the second score it receives. The spliced image is an image formed by splicing a plurality of valid feature fragments according to directions, textures, shapes and other features of the fingerprint pattern.

In some embodiments, one or more spliced images formed by all valid feature fragments may be provided, and the second score may be an area score of the one spliced image, or a sum of area scores of a plurality of spliced images. In some application scenarios, when all the valid feature fragments are spliced into a plurality of spliced images, the area score corresponding to each spliced image may be determined according to a size of the area of each spliced image, where the larger the area of the spliced image, the higher the area score. For an isolated valid feature fragment which cannot be spliced with any other valid feature fragment, the area score may be set to be smaller or set to zero. Then, a sum of the plurality of area scores may be determined as the second score.

In some embodiments, the total score may be determined in step 341 from the sum of first scores of all valid feature fragments solely. In some other embodiments, the total score may be determined in step 341 from the second score of all valid feature fragments solely. In other words, the second score is directly used as the total score. In still other embodiments, the sum of the first scores of all valid feature fragments and the second score may be weighted and summed in step 341 to obtain the total score.

In some other embodiments, the step 341 may include: splicing all valid feature fragments according to correlation among the valid feature fragments, to form a spliced image; determining, according to an area of the spliced image where each valid feature fragment is located and sharpness of each valid feature fragment, a third score that represents an information amount of each valid feature fragment; and determining, according to a sum of third scores of all valid feature fragments, a total score that represents the information amount of all valid feature fragments.

In some embodiments, the correlation among the valid feature fragments may be understood as whether the fingerprint feature points on each respective valid feature fragment conform to the direction, texture, shape, and other features of the fingerprint pattern. In other words, valid feature fragments at corresponding positions which conform to features of the fingerprint pattern in each valid feature fragment may be spliced to form a spliced image. In some other embodiments, the plurality of valid feature fragments in a same spliced image may correspond to a plurality of same or different third scores.

In some application scenarios, the larger the area of the spliced image where the valid feature fragment is located is, and the higher the sharpness of the valid feature fragment is, the higher third score the valid feature fragment may get. In other words, for a spliced image with a larger area and higher sharpness, each valid feature fragment that forms the spliced image may have a higher third score. For a spliced image with a smaller area but higher sharpness, the valid feature fragment therein has a lower third score than the valid feature fragment in the spliced image with a larger area and higher sharpness. For a spliced image with a smaller area and lower sharpness, each valid feature fragment therein has an even lower third score. In some other application scenarios, for the plurality of valid feature fragments in the same spliced image, if the plurality of valid feature fragments have different levels of sharpness, they may also correspond to different third scores.

The solution of determining the total score according to the area of the spliced image provided in the above embodiments helps to ensure that different users can achieve a relatively consistent fingerprint enrollment area under the condition of different counts of presses (i.e., different counts of input fingerprint images).

The process may then proceed to step 342 (shown by a dashed box), in which whether the fingerprint enrollment is completed is determined according to whether the total score reaches a preset threshold. The preset threshold may be set as desired. The total score that reaches the preset threshold may be equal to or greater than the preset threshold. In some embodiments, the step 342 may include: determining, in response to that the total score reaches the preset threshold, that the fingerprint enrollment is completed; or determining, in response to that the total score does not reach the preset threshold, that the fingerprint enrollment is not completed, and acquiring a next fingerprint image, stopping acquiring a new fingerprint image when the total score obtained by all the acquired fingerprint images reaches the preset threshold, and determining that the fingerprint enrollment is completed.

In still other embodiments, the method 300 may further include: displaying a fingerprint enrollment progress based on at least one of: a progress of obtaining the valid feature fragment; or the information amount of the valid feature fragment. In some embodiments, the fingerprint enrollment progress may be displayed in the form of a progress bar. In some other embodiments, the fingerprint enrollment progress may be displayed in the form of texts, such as presenting progress changes in numerical percentages, textual descriptions, or the like. In still other embodiments, the fingerprint enrollment progress may be displayed in the form of images, such as presenting progress changes by changes in colors, lines, integrity, or the like of the image.

In some embodiments, when each valid feature fragment is obtained, the fingerprint enrollment progress may be correspondingly increased by a progress scale of a quantity unit; and/or according to the information amount of each obtained valid feature fragment, the fingerprint enrollment progress may be increased by a progress scale corresponding to the information amount.

For the conventional method for fingerprint enrollment in units of images, assuming that N images are desired to be collected to complete the fingerprint enrollment, then each progress scale of the fingerprint enrollment progress is 1/N. For example, taking N equal to 10 as an example, each time an acceptable fingerprint image is collected, the fingerprint enrollment progress is increased by 10% of the progress scale (or progress increment). For the method according to the embodiment of the present disclosure, taking the case of displaying the fingerprint enrollment progress according to the progress of obtaining the valid feature fragment as an example, assuming that 1000 valid feature fragments are desired to be collected, then each time the valid feature fragment is collected, the fingerprint enrollment progress is increased by 0.1% of the progress scale, where the 0.1% of the progress scale is much less than the 10% of the progress scale. Therefore, with the method according to the embodiment of the present disclosure, the fingerprint enrollment progress displayed is smoother, which is beneficial to improving the visual experience of the user.

While the method for fingerprint enrollment according to another embodiment of the present disclosure is exemplarily described above with reference to FIG. 3, it will be understood that the above description is exemplary and not restrictive. For example, the step 340 may not be limited to determining whether the fingerprint enrollment is completed according to the information amount of the valid feature fragment, and in some other embodiments, it is also possible to determine whether the fingerprint enrollment is completed according to whether a count of the obtained valid feature fragments reaches a count threshold.

Through the above description of the technical solutions and embodiments for fingerprint enrollment of the present disclosure, it will be understood by those skilled in the art that the method for fingerprint enrollment of the present disclosure can quantize each fingerprint image to obtain feature fragments in units of fingerprint feature points, and by taking the feature fragments as a standard for whether the fingerprint enrollment is completed, can make full use of fingerprint information in each fingerprint image to avoid waste of the whole fingerprint image, thereby helping to avoid useless presses on the fingerprint sensor by the user of fingerprint enrollment, and reduce the count of presses by the user.

Further, in some embodiments, by determining whether the fingerprint enrollment is completed according to the information amount of the valid feature fragments, different types of users of fingerprint enrollment (such as good users and poor users) can all reach a uniform enrollment standard, and a relatively consistent information amount is obtained for fingerprint enrollment, which is beneficial to ensuring the fingerprint enrollment quality and effect of each user of fingerprint enrollment.

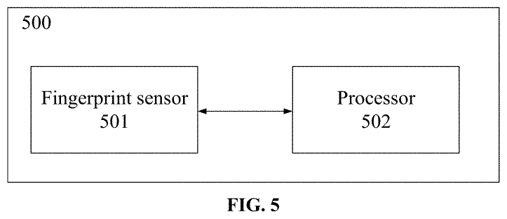

FIG. 5 is a schematic block diagram of a device for fingerprint enrollment according to an embodiment of the present disclosure. As shown in FIG. 5, a device 500 may include: a fingerprint sensor 501, which may be configured to detect a fingerprint image of a finger; and a processor 502, which may be configured to: extract fingerprint feature points of a fingerprint image; fragment the fingerprint image in units of each fingerprint feature point, to obtain a feature fragment corresponding to each fingerprint feature point; and determine, according to whether the feature fragment meets an enrollment condition, whether the fingerprint enrollment is completed.

In some embodiments, the processor 502 may be further configured to: determine a valid feature fragment of the fingerprint image; and determine, according to whether an information amount of the valid feature fragment meets the enrollment condition, whether the fingerprint enrollment is completed.

In some embodiments, the processor 502 may be further configured to: determine, according to fingerprint feature points in each fingerprint image not repetitive with those in other previously acquired fingerprint images, the valid feature fragment of each fingerprint image.

In still other embodiments, the processor 502 may be further configured to: determine, according to a degree of contribution of the valid feature fragment to the fingerprint information, a total score that represents the information amount of all valid feature fragments; and determine, according to whether the total score reaches a preset threshold, whether the fingerprint enrollment is completed.

In some embodiments, in determining the total score according to the degree of contribution, the processor 502 may be further configured to: determine, according to sharpness of each valid feature fragment, a first score that represents an information amount of each valid feature fragment; and/or determine, according to an area of a spliced image formed by all valid feature fragments, a second score that represents an information amount of the spliced image.

In some other embodiments, in determining the total score according to the degree of contribution, the processor 502 may be further configured to: splice all valid feature fragments according to correlation among the valid feature fragments, to form a spliced image; determine, according to an area of the spliced image where each valid feature fragment is located and sharpness of each valid feature fragment, a third score that represents an information amount of each valid feature fragment; and determine, according to a sum of third scores of all valid feature fragments, a total score that represents the information amount of all valid feature fragments.

In still other embodiments, the device 500 may further include: a display; and the processor 502 may be further configured to: control the display to display a fingerprint enrollment progress based on at least one of: a progress of obtaining the valid feature fragment; or the information amount of the valid feature fragment.

In some embodiments, the processor 502 may be further configured to: acquire a next fingerprint image in response to that current pre-enrolled feature fragments do not meet the enrollment condition, until the feature fragments accumulated in all the fingerprint images meet the enrollment condition, and determine that the fingerprint enrollment is completed.

It will be understood that the device of the present disclosure has been described and explained in detail above in conjunction with the method, which will not be repeated here.

In a third aspect, the present disclosure provides a non-transitory computer-readable storage medium having a program for fingerprint enrollment stored thereon which, when executed by a processor, causes any of the above methods described in conjunction with FIGS. 1 to 4B to be performed.

The non-transitory computer-readable storage medium may be any suitable magnetic or magneto-optical storage medium, such as a resistive random access memory (RRAM), a dynamic random access memory (DRAM), a static random access memory (SRAM), an enhanced dynamic random access memory (EDRAM), a high-bandwidth memory (HBM), a hybrid memory cube (HMC), and the like, or any other medium that can be used to store the desired information and that can be accessed by an application, a module, or both. Any such computer storage medium can be a part of a device, or accessible or connectable to a device. Any application or module described in the present disclosure can be implemented by computer-readable/executable instructions stored on such a computer-readable medium or otherwise maintained.

While various embodiments of the present disclosure have been shown and described herein, it will be obvious to those skilled in the art that such embodiments are merely provided by way of example. Numerous modifications, changes, and substitutions will occur to those skilled in the art without departing from the spirit and scope of the present disclosure. It should be understood that various alternatives to the embodiments of the present disclosure described herein may be employed while practicing the present disclosure. It is intended that the following claims define the scope of the present disclosure and that equivalents or alternatives within the scope of these claims are covered thereby.

What is claimed is:

1. A method for fingerprint enrollment, comprising:
extracting fingerprint feature points of a fingerprint image;
fragmenting the fingerprint image in units of each fingerprint feature point, to obtain a feature fragment corresponding to each fingerprint feature point; and
determining, according to whether the feature fragment meets an enrollment condition, whether the fingerprint enrollment is completed.

2. The method of claim 1, further comprising:
determining a valid feature fragment of the fingerprint image; and
determining, according to whether an information amount of the valid feature fragment meets the enrollment condition, whether the fingerprint enrollment is completed.

3. The method of claim 2, wherein the determining of the valid feature fragment of the fingerprint image comprises:
determining, according to fingerprint feature points in each fingerprint image not repetitive with those in other previously acquired fingerprint images, the valid feature fragment of each fingerprint image.

4. The method of claim 2, wherein the determining whether the fingerprint enrollment is completed comprises:
determining, according to a degree of contribution of the valid feature fragment to the fingerprint information, a total score that represents the information amount of all valid feature fragments; and
determining, according to whether the total score reaches a preset threshold, whether the fingerprint enrollment is completed.

5. The method of claim 4, wherein the determining of the total score comprises:
determining, according to sharpness of each valid feature fragment, a first score that represents an information amount of each valid feature fragment; and/or
determining, according to an area of a spliced image formed by all valid feature fragments, a second score that represents an information amount of the spliced image.

6. The method of claim 4, wherein the determining of the total score comprises:
splicing all valid feature fragments according to correlation among the valid feature fragments, to form a spliced image;
determining, according to an area of the spliced image where each valid feature fragment is located and sharpness of each valid feature fragment, a third score that represents an information amount of each valid feature fragment; and
determining, according to a sum of third scores of all valid feature fragments, a total score that represents the information amount of all valid feature fragments.

7. The method of claim 2, further comprising:
displaying a fingerprint enrollment progress based on at least one of:
a progress of obtaining the valid feature fragment; and
the information amount of the valid feature fragment.

8. The method of claim 1, wherein the determining whether the fingerprint enrollment is completed comprises:
acquiring a next fingerprint image in response to that current pre-enrolled feature fragments do not meet the enrollment condition, until the feature fragments accumulated in all the fingerprint images meet the enrollment condition, and determining that the fingerprint enrollment is completed.

9. A device for fingerprint enrollment, the device comprising:
a fingerprint sensor configured to detect a fingerprint image of a finger; and
a processor configured to:
extract fingerprint feature points of a fingerprint image;
fragment the fingerprint image in units of each fingerprint feature point, to obtain a feature fragment corresponding to each fingerprint feature point; and
determine, according to whether the feature fragment meets an enrollment condition, whether the fingerprint enrollment is completed.

10. The device of claim 9, wherein the processor is further configured to:
determine a valid feature fragment of the fingerprint image; and
determine, according to whether an information amount of the valid feature fragment meets the enrollment condition, whether the fingerprint enrollment is completed.

11. The device of claim 10, wherein the processor is further configured to:
determine, according to fingerprint feature points in each fingerprint image not repetitive with those in other previously acquired fingerprint images, the valid feature fragment of each fingerprint image.

12. The device of claim 10, wherein the processor is further configured to:
determine, according to a degree of contribution of the valid feature fragment to the fingerprint information, a total score that represents the information amount of all valid feature fragments; and
determine, according to whether the total score reaches a preset threshold, whether the fingerprint enrollment is completed.

13. The device of claim 12, wherein in determining the total score according to the degree of contribution, the processor is further configured to:
determine, according to sharpness of each valid feature fragment, a first score that represents an information amount of each valid feature fragment; and/or
determine, according to an area of a spliced image formed by all valid feature fragments, a second score that represents an information amount of the spliced image.

14. The device of claim 12, wherein in determining the total score according to the degree of contribution, the processor is further configured to:
splice all valid feature fragments according to correlation among the valid feature fragments, to form a spliced image;
determine, according to an area of the spliced image where each valid feature fragment is located and sharpness of each valid feature fragment, a third score that represents an information amount of each valid feature fragment; and
determine, according to a sum of third scores of all valid feature fragments, a total score that represents the information amount of all valid feature fragments.

15. The device of claim 10, further comprising:
a display; and
the processor further configured to control the display to display a fingerprint enrollment progress based on at least one of a progress of obtaining the valid feature fragment and the information amount of the valid feature fragment.

16. The device of claim 9, wherein the processor is further configured to:
acquire a next fingerprint image in response to that current pre-enrolled feature fragments do not meet the enrollment condition, until the feature fragments accumulated in all the fingerprint images meet the enrollment condition, and determine that the fingerprint enrollment is completed.

17. A non-transitory computer-readable storage medium having a program for fingerprint enrollment stored thereon which, when executed by a processor, causes the method of claim 1 to be performed.
